(19) United States
(12) Patent Application Publication
(10) Pub. No.: US 2025/0225388 A1
(43) Pub. Date: Jul. 10, 2025

(54) A METHOD, AN APPARATUS AND A COMPUTER PROGRAM PRODUCT FOR MACHINE LEARNING

(71) Applicant: Nokia Technologies Oy, Espoo (FI)

(72) Inventors: Hamed REZAZADEGAN TAVAKOLI, Espoo (FI); Francesco CRICRÌ, Tampere (FI); Honglei ZHANG, Tampere (FI); Emre Baris AKSU, Tampere (FI); Miska Matias HANNUKSELA, Tampere (FI)

(21) Appl. No.: 18/867,290

(22) PCT Filed: Apr. 14, 2023
(86) PCT No.: PCT/EP2023/059788

§ 371 Date: Nov. 19, 2024

(30) Foreign Application Priority Data
May 20, 2022 (FI) 20225442

(51) Int. Cl. G06N 3/08; G06N 3/0455

(52) U.S. Cl. CPC G06N 3/08; G06N 3/0455

(57) ABSTRACT

The embodiments relate to a global set of features that are generated, refined and used in encoding and decoding, wherein the global set of features are targeted to collaborative inference.

### TECHNICAL FIELD

The present solution generally relates to machine learning, and in particularly to a collaborative machine learning.

### BACKGROUND

One area of machine learning is collaborative machine learning. This includes several areas, for example collaborative learning and collaborative inference. In the latter, two devices collaborate so that one device extract features from an input data, whereupon another device uses the extracted data for solving a problem.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus comprising means for extracting one or more features from an input data by a first machine learning model; means for performing a task on said one or more features by a second machine learning model; means for clustering the extracted features by a third machine learning model according to a similarity of the extracted features into one or more clusters; means for generating the global set of features from a centroid of each cluster; means for training a feature extractor to extract features to said one or more clusters so that the task is performed with a minimal loss based on a cost value calculation.

According to an embodiment the further comprises means for reducing feature dimension, wherein said means for reducing feature dimension is trained along the means for clustering.

According to an embodiment the global set of features comprises blocks or structures of a feature.

According to a second aspect, there is provided an apparatus for refining a global set of features, comprising means for extracting one or more features from an input data by a first machine learning model; means for determining a closest feature of the one or more extracted features from a global set of features; means for determining a residual between the one or more extracted features and the closest feature; means for generating a compressed residual from the residual. means for determining a compression loss from the compressed residual; means for generating a reconstructed feature from the compressed residual and the closest feature; means for determining a construction loss from the reconstructed feature and the one or more extracted features.

According to an embodiment, the apparatus comprises means for finetuning the global set of features by minimizing the compression loss and the reconstruction loss.

According to an embodiment, the apparatus comprises means for finetuning a feature extractor by minimizing the compression loss and the reconstruction loss.

According to an embodiment, the global set of features has been created by apparatus of the first aspect.

According to a third aspect, there is provided an apparatus for encoding, comprising means for receiving input data; means for extracting one or more features from said input data by using a machine learning model; means for determining one or more closest features for an extracted feature from a global set of learned features, said global set of learned features having been determined as a result of training a machine learning model to determine centroids from clusters of features; determining an anchor feature from the one or more of the closest features; means for determining a residual between an extracted feature and the anchor feature; means for encoding the residual and information for obtaining the anchor feature into a bitstream; and means for encoding a feature representation into a bitstream.

According to an embodiment, the information for obtaining the anchor feature is an index of the feature in the set of learned features.

According to an embodiment, the information for obtaining the anchor feature is an approximation function.

According to an embodiment, the apparatus further comprises means for selecting more than one closest features from a global set of learned features randomly.

According to an embodiment, the apparatus further comprises means for selecting more than one closest features from a global set of learned features by optimizing a rate distortion loss function.

According to an embodiment, the apparatus further comprises means for determining the number of said more than one closest features by an agreement with the decoder.

According to an embodiment, the global set of features has been created by apparatus of the first aspect.

According to a fourth aspect, there is provided an apparatus for decoding, comprising means for receiving an encoded bitstream: means for decoding from the bitstream a residual and information for obtaining an anchor feature; means for decoding a feature representation from the bitstream; means for obtaining an anchor feature from a global set of learned features by using the information; and means for reconstructing an input data by adding the anchor feature to the residual.

According to a fifth aspect, there is provided a method for generating a global set of features, comprising extracting one or more features from an input data by a first machine learning model; performing a task on said one or more features by a second machine learning model; clustering the extracted features by a third machine learning model according to a similarity of the extracted features into one or more clusters; generating the global set of features from a centroid of each cluster; training a feature extractor to extract features to said one or more clusters so that the task is performed with a minimal loss based on a cost value calculation.

According to a sixth aspect, there is provided a method for refining a global set of features, comprising extracting one or more features from an input data by a first machine learning model; determining a closest feature of the one or more extracted features from a global set of features; determining a residual between the one or more extracted features and the closest feature; generating a compressed residual from the residual; determining a compression loss from the compressed residual; generating a reconstructed feature from the compressed residual and the closest feature; determining a construction loss from the reconstructed feature and the one or more extracted features.

According to a seventh aspect, there is provided a method for encoding, comprising receiving input data; extracting one or more features from said input data by using a machine learning model; determining one or more closest features for an extracted feature from a global set of learned features, said global set of learned features having been determined as a result of training a machine learning model to determine centroids from clusters of features; determining an anchor feature from the one or more of the closest features; determining a residual between an extracted feature and the anchor feature; encoding the residual and information for obtaining the anchor feature into a bitstream; and encoding a feature representation into a bitstream.

According to an eighth aspect, there is provided a method for decoding, comprising: receiving an encoded bitstream: decoding from the bitstream a residual and information for obtaining an anchor feature; decoding a feature representation from the bitstream; obtaining an anchor feature from a global set of learned features by using the information; and reconstructing an input data by adding the anchor feature to the residual.

According to a ninth aspect, there is provided an apparatus comprising at least one processor, memory including computer program code, the memory and the computer program code configured to, with the at least one processor, cause the apparatus to perform at least the following:
extract one or more features from an input data by a first machine learning model;
perform a task on said one or more features by a second machine learning model;
cluster the extracted features by a third machine learning model according to a similarity of the extracted features into one or more clusters;
generate the global set of features from a centroid of each cluster;
train a feature extractor to extract features to said one or more clusters so that the task is performed with a minimal loss based on a cost value calculation.

According to a tenth aspect, there is provided an apparatus comprising at least one processor, memory including computer program code, the memory and the computer program code configured to, with the at least one processor, cause the apparatus to perform at least the following:
extract one or more features from an input data by a first machine learning model;
determine a closest feature of the one or more extracted features from a global set of features;
determine a residual between the one or more extracted features and the closest feature;
generate a compressed residual from the residual.
determine a compression loss from the compressed residual;
generate a reconstructed feature from the compressed residual and the closest feature;
determine a construction loss from the reconstructed feature and the one or more extracted features.

According to a eleventh aspect, there is provided an apparatus comprising at least one processor, memory including computer program code, the memory and the computer program code configured to, with the at least one processor, cause the apparatus to perform at least the following:
receive input data;
extract one or more features from said input data by using a machine learning model;
determine one or more closest features for an extracted feature from a global set of learned features, said global set of learned features having been determined as a result of training a machine learning model to determine centroids from clusters of features;
determine an anchor feature from the one or more of the closest features;
determine a residual between an extracted feature and the anchor feature;
encode the residual and information for obtaining the anchor feature into a bitstream; and
   encode a feature representation into a bitstream.

According to a twelfth aspect, there is provided an apparatus comprising at least one processor, memory including computer program code, the memory and the computer program code configured to, with the at least one processor, cause the apparatus to perform at least the following:
receive an encoded bitstream:
decode from the bitstream a residual and information for obtaining an anchor feature;
decode a feature representation from the bitstream;
obtain an anchor feature from a global set of learned features by using the information; and
reconstruct an input data by adding the anchor feature to the residual.

According to a thirteenth aspect, there is provided computer program product comprising computer program code configured to, when executed on at least one processor, cause an apparatus or a system to implement any of the methods of fifth, sixth, seventh and eighth aspect.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows a high-level design of a framework for collaborative inference;

FIG. 2 shows an architecture according to an embodiment for learning a global feature consensus (GFC);

FIG. 3 shows an architecture according to another embodiment for learning a GFC;

FIG. 4 shows an architecture for learning a GFC in a residual encoding based pipeline according to an embodiment;

FIG. 5 shows an architecture with linear feature mapping (LFM) according to an embodiment for learning GFC;

FIG. 6 shows an embodiment of a residual coding;

FIG. 7 shows an embodiment of a predictive coding;

FIG. 8a is a flowchart illustrating a method for generating a global set of features according to an embodiment;

FIG. 8b is a flowchart illustrating a method for refining a global set of features according to an embodiment;

FIG. 8c is a flowchart illustrating a method for encoding according to an embodiment;

FIG. 9 is a flowchart illustrating a method for decoding according to an embodiment; and

FIG. 10 shows an apparatus according to an embodiment.

### DESCRIPTION OF EXAMPLE EMBODIMENTS

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment in included in at least one embodiment of the disclosure.

Before discussing the present embodiments in more detailed manner, a short reference to related technology is given.

Machine learning refers to algorithms (i.e., models) that are able to learn through experience and improve their performance based on learning. One of the areas of machine learning is collaborative machine learning. The collaborative machine learning can include several areas, for example, 1) collaborative learning; and 2) collaborative inference. In collaborative learning, a model is learned collaboratively as in federated learning, where the learned models on local data are exchanged between devices (or institutes) until a global model is obtained. In collaborative inference, a problem is collaboratively solved, where features extracted on one device (or an institute) can become available to another device (or another institute) who uses those features for solving a problem. It is to be noticed that in this disclosure term “device” will be used to refer to a physical device or to an institute. An institute as such is an entity, e.g., a hospital, a school, a factory, an office building. However, for simplicity, term “device” in this disclosure should be interpreted to cover both the physical device and the institute.

A special case of collaborative inference is under study in Video Coding for Machines (VCM) exploration of the Moving Picture Experts Group (MPEG), where a video is processed by a neural network and the features extracted by a neural network are encoded for the consumption of other devices. A neural network (NN) is a computation graph consisting of several layers of computation, where each layer may perform a certain intermediate phase, e.g., feature extraction, being directed to a final task. The final layer of the NN may perform the final task (e.g., classification, prediction, recognition, decision) based on the extracted features.

Each layer consists of one or more units, where each unit performs an elementary computation. A unit is connected to one or more other units, and the connection may have associated with a weight. The weight may be used for scaling the signal passing through the associated connection. Weights are learnable parameters, i.e., values which can be learned from training data. There may be other learnable parameters, such as those of batch-normalization layers. Neural networks are being utilized in an ever-increasing number of applications for many different types of devices, such as mobile phones. Examples include image and video analysis and processing, social media data analysis, device usage data analysis, etc.

Training a neural network is an optimization process, where the output's error, also referred to as the loss, is usually minimized or decreased. Examples of losses are mean squared error, cross-entropy, etc. In recent deep learning techniques, training is an iterative process, where at each iteration the algorithm modifies the weights of the neural net to make a gradual improvement of the network's output, i.e., to gradually decrease the loss.

Video Coding for Machines (VCM) relates to the set of tools and concepts for compressing and decompressing data for machine consumption. VCM concerns the encoding of video streams to allow consumption for machines. Machine is referred to indicate any device except human. Example of machine can be a mobile phone, an autonomous vehicle, a robot, and such intelligent devices which may have a degree of autonomy or run an intelligent algorithm to process the decoded stream beyond reconstructing the original input stream. Within the context of VCM, “task machine” and “machine” and “task neural network” are referred to interchangeably.

A machine may perform one or multiple tasks on the decoded stream. Examples of tasks may comprise the following:
Classification: classify an image or video into one or more predefined categories. The output of a classification task may be a set of detected categories, also known as classes or labels. The output may also include the probability and confidence of each predefined category.
Object detection: detect one or more objects in a given image or video. The output of an object detection task may be the bounding boxes and the associated classes of the detected objects. The output may also include the probability and confidence of each detected object.
Instance segmentation: identify one or more objects in an image or video at the pixel level. The output of an instance segmentation task may be binary mask images or other representations of the binary mask images, e.g., closed contours, of the detected objects. The output may also include the probability and confidence of each object for each pixel.
Semantic segmentation: assign the pixels in an image or video to one or more predefined semantic categories. The output of a semantic segmentation task may be binary mask images or other representations of the binary mask images, e.g., closed contours, of the assigned categories. The output may also include the probability and confidence of each semantic category for each pixel.
Object tracking: track one or more objects in a video sequence. The output of an object tracking task may include frame index, object ID, object bounding boxes, probability, and confidence for each tracked object.
Captioning: generate one or more short text descriptions for an input image or video. The output of the captioning task may be one or more short text sequences.
Human pose estimation: estimate the position of the key points, e.g., wrist, elbows, knees, etc., from one or more human bodies in an image of the video. The output of a human pose estimation includes sets of locations of each key point of a human body detected in the input image or video.
Human action recognition: recognize the actions, e.g., walking, talking, shaking hands, of one or more people in an input image or video. The output of the human action recognition may be a set of predefined actions, probability, and confidence of each identified action.
Anomaly detection: detect abnormal object or event from an input image or video. The output of an anomaly detection may include the locations of detected abnormal objects or segments of frames where abnormal events detected in the input video.

The receiver-side device may have multiple “machines” or task neural networks (Task-NNs). These multiple machines may be used in a certain combination which is for example determined by an orchestrator sub-system. The multiple machines may be used for example in succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of all the pixels in the frames.

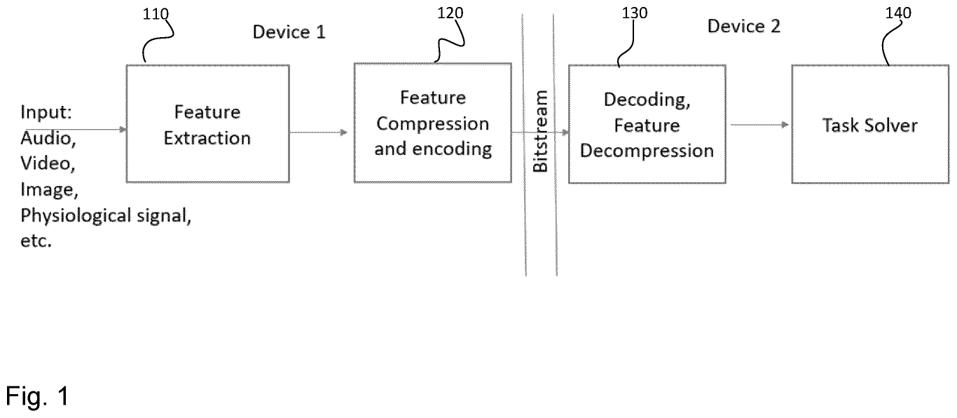

As mentioned above, a special case of collaborative inference relating to the machine learning is under study in MPEG VCM exploration. A high-level design of a framework for collaborative inference is illustrated in FIG. 1.

As shown in FIG. 1, Device 1 (or an institute) is configured to extract 110 features from an input data (e.g., audio, video, image, physiological signal, or alike) by a neural network, for example. The extracted features are compressed and encoded 120 into a bitstream. Device 2 (i.e., or an institute) receives and decodes 130 the bitstream, and decompresses the features encoded therein. Device 2 is configured to use the features for solving 140 a problem.

Compressing (element 120 in FIG. 1) the extracted features can be difficult and nontrivial because features extracted by a specific deep neural network or other machine learning algorithm can be large. For example, the features extracted by a deep neural network can be a tensor of size 10×10×2048=204800 or 64×64×256=1048576 elements of 32-bit floating point values.

The present embodiments are targeted to the compression of features extracted using deep neural networks for collaborative inference.

To address the compression of features by deep neural networks for collaborative inference, the present embodiments provide the following:
a mechanism for learning a global feature consensus, which enables efficient coding of compressed features extracted by deep neural networks;
a system design and architecture for a system based on predictive coding using the concept of global feature consensus;
semantical elements to be signaled and exchanged between devices that participate in collaborative inference using the proposed global feature consensus.

Before discussing the embodiments in more detailed manner, a few terms are defined.

“Global feature consensus (GFC)” refers to a set of learned features that are available to all the devices in a collaborative inference scenario.

“Feature extractor (FX)” is a deep NN that is pre-trained on some dataset to extract features in a collaborative inference scenario. FX can be frozen where no gradient can be propagated to the weights of this NN during the training, or alternatively can be trained and fine-tuned. Freezing is a term referring to an operation, where no gradients are back-propagated during a learning process

“Fixed feature extractor (FFX)” is a deep NN that is pre-trained on some dataset and will be used as feature extractor in collaborative inference. The weights of this network are frozen and no gradient will be backpropagated to the weights of this NN.

“Task NN” is one or more NNs that are solving at least one task.

“Task loss” is one or more loss functions that enable the Task NN to be trained, for example in image classification this loss function may be a cross-entropy function.

“Clustering loss” is one or more loss functions that may be used to cluster data points.

“Feature encoder” and “feature decoder” are components in a feature codec that compress and decompress the features in a compression pipeline.

“Anchor feature” is a feature that is used as a reference or basis to perform some computational process such as residual calculation, estimation, prediction or similar operations.

In the following the various areas of the present embodiments are discussed in more detailed manner.

### Learning a Global Feature Consensus

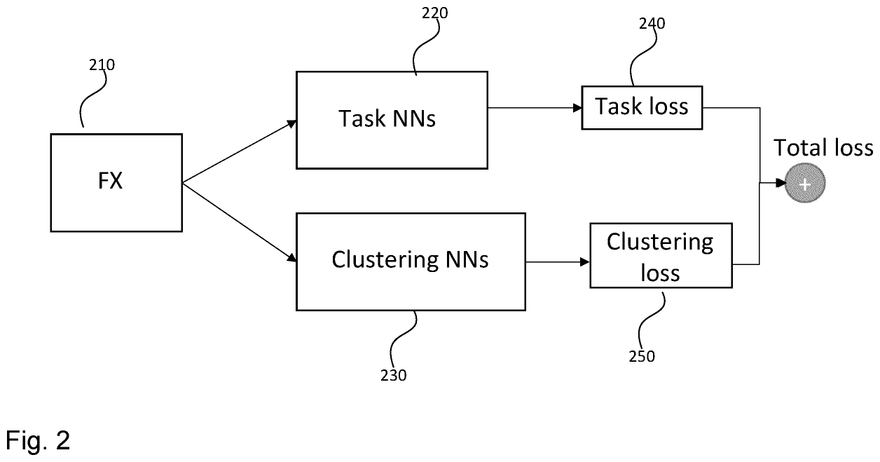

FIG. 2 illustrates an architecture and algorithm according to a first embodiment to obtain global feature consensus (GFC), i.e., a set of learned features that are available to all devices. As defined above, feature extractor (FX) 210 is a deep NN that is pre-trained on some dataset to extract features. The architecture comprises one or more NNs solving at least one task (for example classification, recognition, or any other task as defined above). These NNs are referred to as Task NNs 220. The architecture also comprises one or more NNs used for clustering the extracted features. These NNs are referred to as Clustering NNs 230.

The clustering occurs through a clustering loss 250 that is being defined. A GFC's can be considered as the centroid of the clusters of the features. The purpose of the clustering is to force FX to generate features for a cluster. The clustering NN 230 converts an input feature into another representation so the clustering loss may be applied.

A task NN 220 is configured to determine when a task can still be performed based on features that have been extracted for the clusters. In other words, the purpose of the task NN 220 is to test whether the clustered features achieves the task with minimal loss based on a cost value calculation, which loss is defined as task loss 240.

Task NNs 220 is trained with a task loss 240 that comprises one or more loss functions. Clustering loss 250 refers to one or more loss functions that may be used to cluster data points. One form of the clustering loss may be based on information theory, for example, to the mutual information between the input variable and the output variable of the clustering NN 230. The clustering loss 250 considers some distance or similarity metric between feature representation or their normalized representation, e.g., KL-divergence, mutual-information or similar metrics. Thus, the clustering loss indicates how similar or distant two features are, and aims to form groups of features based on their distance from each other.

Total loss may be the weighted sum of task loss 240 and clustering loss 250. For example, in an image classification task, the task loss could be a cross entropy and the total loss could be a weighted average between the cross entropy loss and the clustering loss. In another example, the task loss could consists of one or more losses, e.g., the cross entropy loss and a regularization loss such as Li-norm. A regularization loss is an extra term added to the loss function in order to guide the optimization in a desired way. In some cases, the task loss may consist of multiple losses where multiple tasks are solved.

Back-propagation may be used to obtain the gradients of the output of a FX with respect to its input. Freezing is a term referring to an operation, where no gradients are back-propagated during a learning process.

The first algorithm to obtain the GFC using the architecture of FIG. 2 may comprise the following steps:
as an optional step, freezing the FX 210;
training the one or more subnetworks, for example a Task NNs 220 and a Clustering NNs 230 for each input data;
receiving the number of clusters from the user based on the expected size of the GFC. Alternatively, the number of clusters may be determined as a hyper-parameter until a predefined task performance is achieved;
after the training, taking the cluster centers as the GFC and saving them along the FX. A cluster center may be the average of the features that belong to the same cluster, i.e., they are representative of the features that belong to the cluster.

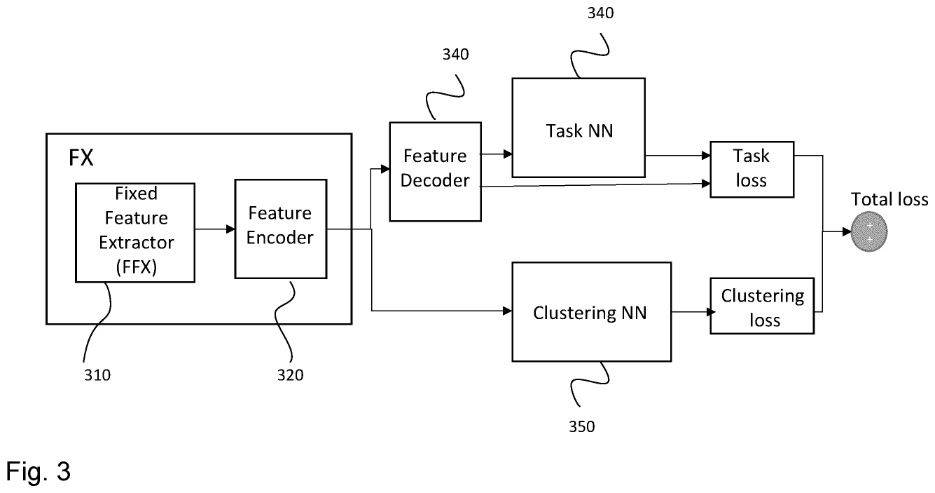

FIG. 3 illustrates an architecture and algorithm according to a second embodiment to obtain GFC. This architecture comprises a Fixed Feature Extractor (FFX) 310, which is a deep NN that is pre-trained on a dataset to extract features. Also, the architecture of FIG. 3 comprises a feature encoder 320 and feature decoder 340 used for compressing and decompressing the features.

The second algorithm for the architecture of FIG. 3 may comprise the following steps:
freezing FFX 310 and the task NN 340;
during training of the subnetworks, for each input data, training the feature encoder 320, feature decoder 340, and clustering NN 350;
receiving the number of clusters from the user based on the expected size of GFC. Alternatively, the number of clusters may be determined as a hyper-parameter until a predefined task performance is achieved;
after the training, taking the cluster centers as the GFC and saving them along the feature encoder 320.

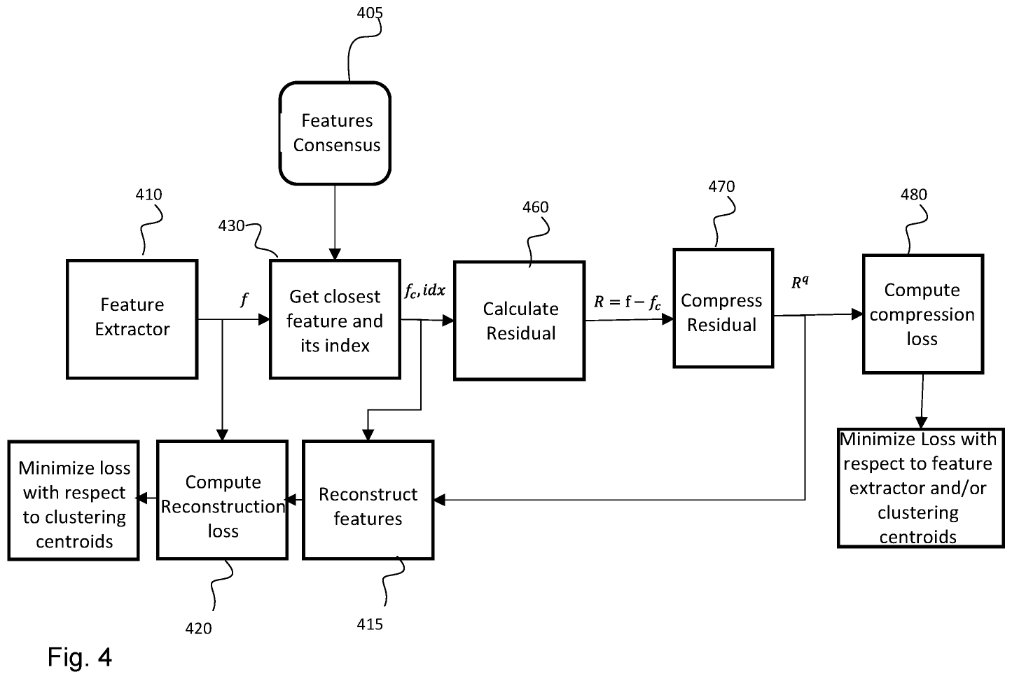

The GFC and feature extractor learned using the first or the second algorithm may be further finetuned in a compression pipeline. FIG. 4 illustrates an example of finetuning the GFC and/or feature extractor in a conjunction with a compression pipeline according to an embodiment. In this architecture, a feature extractor (i.e., FX) 410 performs feature extraction. For a feature ƒ, a closest feature ƒ_{c} and its index is determined 430 from the set of features consensus (i.e., GFC) 405. The closest feature ƒ_{c} represents an anchor feature. A compression loss is computed 480 based on the residual, that has been calculated 460 and compressed 470. The residual R is a difference between the extracted feature ƒ and the anchor feature ƒ_{c}. A reconstruction loss 420 is computed on the reconstructed features 415. In one example, the feature extractor may be fixed and the GFC is finetuned by minimizing the compression loss and reconstruction loss. Alternatively, the feature extractor 410 may also be trained.

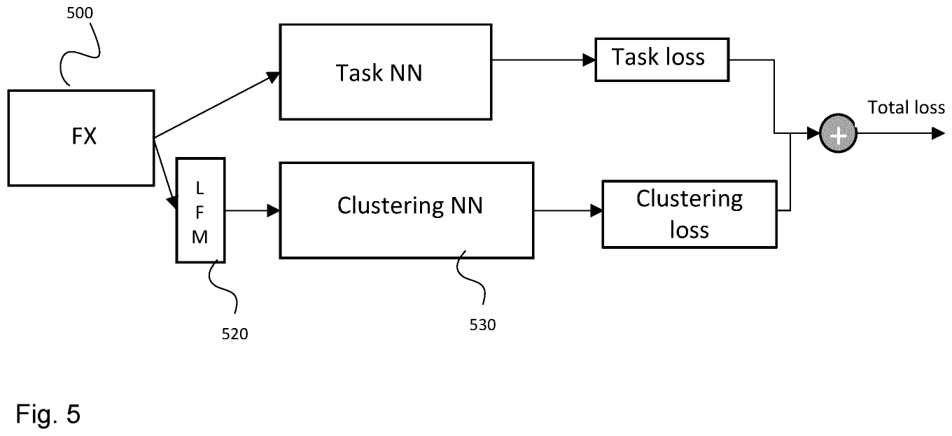

FIG. 5 illustrates an example of GFC architecture with linear feature mapping (LFM) 520 according to an embodiment. LFM 520 performs feature dimension reduction by a function ƒ: Rⁿ→R^{m}, where m<n, to facilitate easier clustering and feature matching during the coding process. The LFM 520 layer is trained along the clustering NN and deployed with the clustering NN 530. An example implementation of function ƒ may be convolution layer with kernel size 1×1 or a multilayer perceptron.

In an alternative embodiment, the GFC can be obtained to consist of blocks or structures of feature. In this case, if the output of the FX 500 is presented as F, which can be a tensor, such tensor may consist of smaller sub-tensors, i.e., F={F₁, F₂, . . . , Fₙ} where the sub-tensors are used as the input to the clustering NN 530. Thus, the cluster centers correspond to the sub-tensors.

### Utilizing the Global Feature Consensus in a Coding Pipeline

After learning the GFC, the learned feature consensus can be utilized in feature coding. For this purpose, possible implementations are discussed next within a coding pipeline.

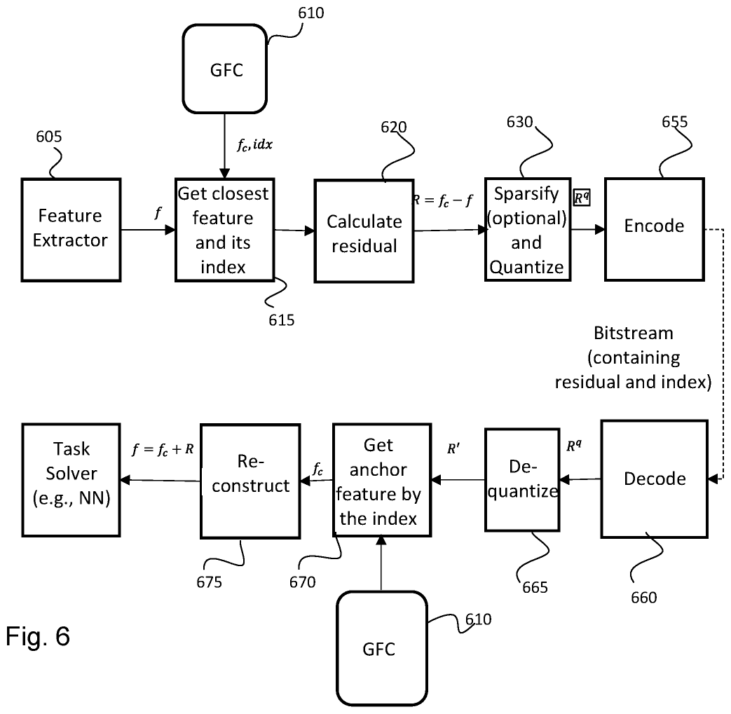

FIG. 6 illustrates an architecture A residual coding according to an embodiment. The feature extractor 605 performs extraction of feature ƒ and uses GFC 610 to get 615 the closest feature ƒ_{c} and its index idx. In this architecture the GFC 610 is small, i.e., the number of features in the GFC 610 set is far less than the dimension of the feature ƒ, for example, 10 versus 1000. The access to GFC 610 may be implemented with some fast caching approach, hashing mechanism, a KD-tree search or Voronoi-based search tree, or similar technique. A residual R is calculated 620 between the feature ƒ and the closest feature ƒ_{c}. The residual R may be optionally sparsified before being quantized 630. An encoding device 655 may send a bitstream comprising a compressed residual and the index of the anchor feature ƒ_{c} in GFC to a decoding device. The encoding device 655 may consist of entropy coding tools such as Huffman coding and/or arithmetic coding variants like context-adaptive binary arithmetic coding (CABAC).

A decoder may decode 660 the residual R and the index idx from the bitstream, and dequantize 665 the residual R. The decoder may use the index idx to fetch 670 the anchor feature ƒ_{c} from the GFC 610. The anchor feature ƒ_{c} is used with the residual R to reconstruct the input signal ƒ=ƒ_{c}+R.

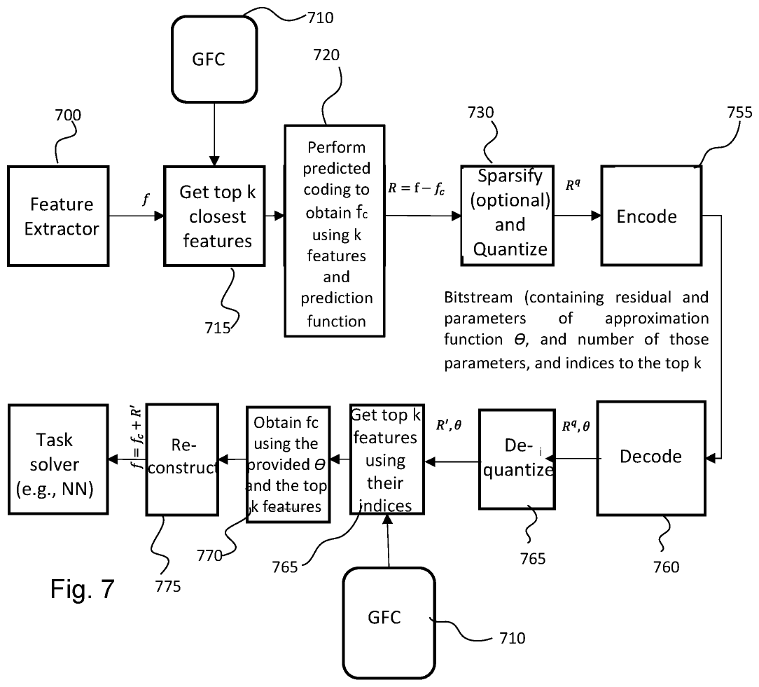

FIG. 7 illustrates an architecture B predictive coding according to an embodiment. This architecture considers using multiple features from the GFC 710 in a predictive coding pipeline for compression of features extracted 700 using DNNs. The feature extractor 700 performs extraction of features ƒ and uses GFC 710 to get 715 top k closest features. An anchor feature ƒ_{c} may be derived 720 by an approximation function with parameter θ using multiple features in the GFC. The approximation function may be a linear function or a non-linear function. A residual R is calculated between the feature ƒ and the anchor feature ƒ_{c}. The residual R may be optionally sparsified and quantized 730. An encoding device 755 may send a bitstream comprising the compressed residual, parameters of the approximation function, numbers of those parameters, and indices to the top k closest features to a decoding device.

The decoding device may decode 760 the bitstream to obtain the residual and the approximation function, and dequantize 765 the residual R. The decoder may use the indices idx to fetch 765 the top k features from the GFC 710, and obtain 770 the anchor feature ƒ_{c} by using the provided parameters of the approximation function and the fetched top k features. The anchor feature ƒ_{c} is used with the residual R to reconstruct 775 the input signal ƒ=ƒ_{c}+R.

According to an embodiment, the GFC may consist of several features that are always used for predictive coding. For example, always used in the approximation function. In such case, the bitstream may compromise of the parameters of the approximation function, the number of those parameters, and the compressed residual.

According to another embodiment, the top k features from the GFC may be chosen randomly, for example using a pre-defined or indicated random number generation algorithm.

According to another embodiment, the top k features from the GFC may be selected by optimizing a rate distortion loss function where the distortion loss is the distance between the input feature and the reconstructed features and the rate loss is the size of the bitstream containing at least the compressed residual, and parameters θ of approximation function and the indices of the top k features in GFC.

According to another embodiment, the number of features selected from GFC, i.e., number k, may be agreed between devices, e.g., become available via a Uniform Resource Identifier (URI) or in a handshake between devices.

According to another embodiment, the type of approximation function may be communicated from the encoding device to the decoding device for example as part of the bitstream or using an out of band mechanism.

According to another embodiment, the predicted function may be dynamically selected. The approximation function may be changed at different instances of encode and decode procedure.

An independently parsable portion of a bitstream may be such that it can be transmitted, parsed, and/or decoded independently of other portions of the bitstream. An independently parsable portion may be enclosed in an elementary unit of the bitstream, which may be separated from other elementary units for example through start codes that only appear at the beginning of elementary units or by prefixing each elementary unit by its length, e.g. in bytes.

In an embodiment, which may be applied with the encoding function described with embodiments related to FIG. 6 or 7, encoding of the bitstream is arranged in a manner that the bitstream comprises two or more independently parsable portions, where a first portion comprises the index(es) idx and a second portion comprises residual R.

In an embodiment, which may be applied with the encoding function described with embodiments related to FIG. 6 or 7, the residual R. is encoded at multiple sparsification and/or quantization levels resulting into several levels of residual refinements. Each sparsification and/or quantization level may be encoded into an independently parsable portion of the bitstream. In a embodiment the index(es) idx is encoded into a first independently parsable portion and the coarsest sparsification and/or quantization level of the residual R. is encoded into a second independently parsable portion, while in another embodiment, the index(es) idx and the coarsest sparsification and/or quantization level of the residual R. are encoded into the same independently parsable portion.

In an embodiment, a device selects the independently parsable portions that are transmitted or decoded, wherein the device may, for example, be an encoding device, a server or transmitting device, a client or receiving device, or a decoding device. The selection may be based on one or more of the following:
Available bitrate for transmission
Available decoding capacity
Capability for progressive transmission and/or decoding where the bitstream is decoded and the task is performed at multiple steps with finer level residual refinements

In an embodiment, which may be applied with the decoding function described with embodiments related to FIG. 6 or 7, a bitstream with multiple independently parsable portions is received, where a first portion may comprise the index(es) idx and other portions may comprise encoded residual R. at different sparsification and/or quantization levels. A decoder decodes the independently parsable portions in an order that results into decoded residual being refined portion by portion. A decoder may output reconstructed signal after decoding each independently parsable portion.

The FX output may be rearranged according to an embodiment. Such rearrangement may be performed by using a metric such as energy level, entropy, self-information. This will enable learning a better GFC, and obtaining a better compression during coding. The arrangement information is transferred as part of the coded information whereas the output of FX is rearranged according to this information after decoding process at the decoder side.

Instead of learning the GFC offline, a GFC may be dynamically created according to an embodiment. In such embodiment, a random feature tensor or block of feature (sub-tensor) is selected at every T time interval. This randomly chosen tensor or sub-tensor is broadcasted and saved in the GFC. The subsequent feature tensors can be coded using the newly created GFC, following the architectures of the previous embodiments. Alternatively, the GFC may contain only the last randomly selected tensor or sub-tensor. The GFC may be stored in one or more global storage devices and be available to several devices within the time-interval T. Instead of broadcasting, the random feature tensor or block of features (sub-tensor), one may derive a seed number for generating the random feature tensor or block of features. In this case, the seed number is broadcasted to further reduce the communication bandwidth.

### Semantic Definitions

The following semantical elements are required for the above architectures to work properly in a coding pipeline.

GFC_idx is a list or set of indices that are communicated between two devices during coding of features using GFC. Such a set may contain numerical indices or unique names for identifying the GFC. One alternative would be that GFC be represented as a bitmask that represents the chosen features from the GFC. The GFC_idx may be further compressed by some coding mechanism such as exponential Golomb encoding, Huffman coding, or any arithmetic coding variant like CABAC.

Predictive_coef is a list or set of coefficients that are communicated between two devices when using the predictive coding of GFCs. The coefficients may have been compressed using some lossless compression technique or be limited to a specific bit-precision.

Partition_id is an identifier to indicate the partitioning type for obtaining sub-tensors.

feature_order is a set of indices that indicates the rearrangement of features. Such indices may be provided as a compressed bitmask.

Random_feature_seed is a seed number value that could be broadcasted for allowing generation of a random feature tensor or block of features.

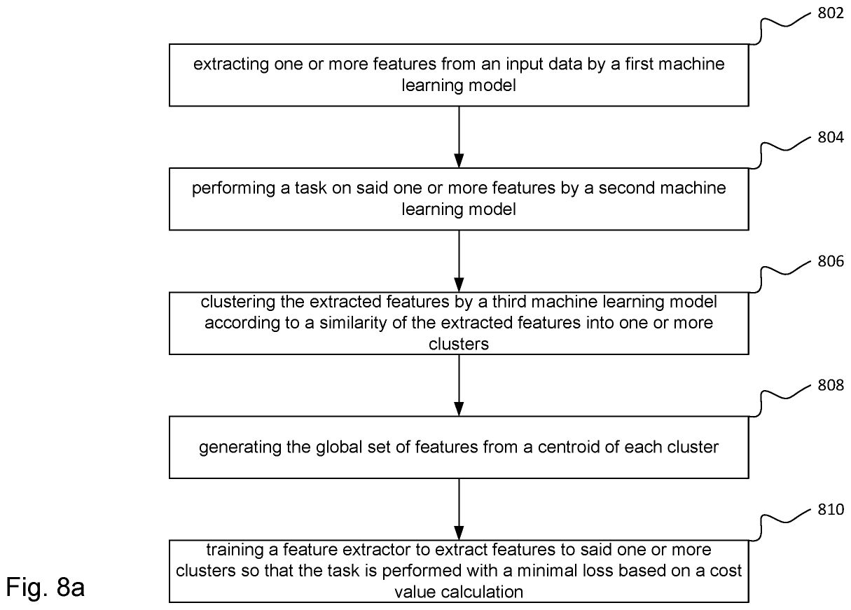

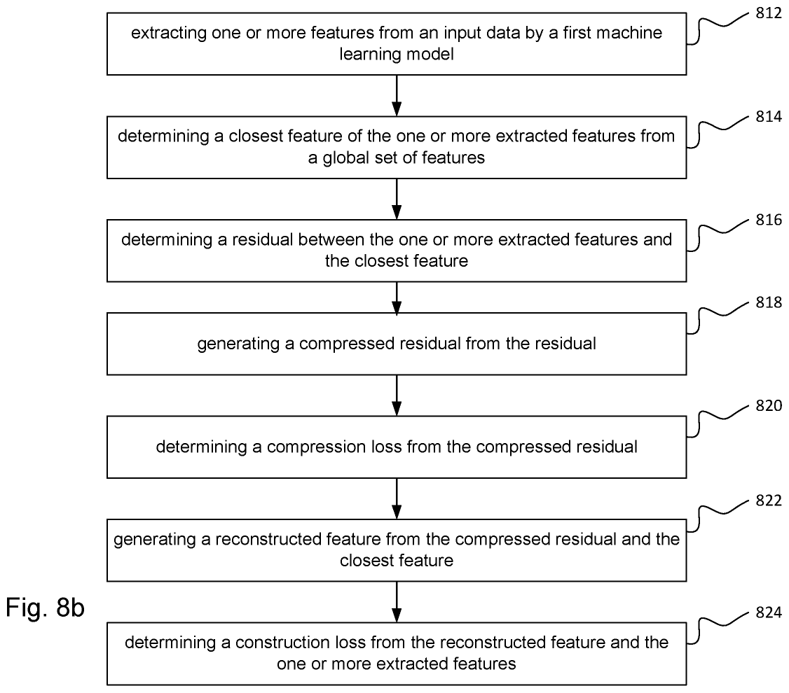

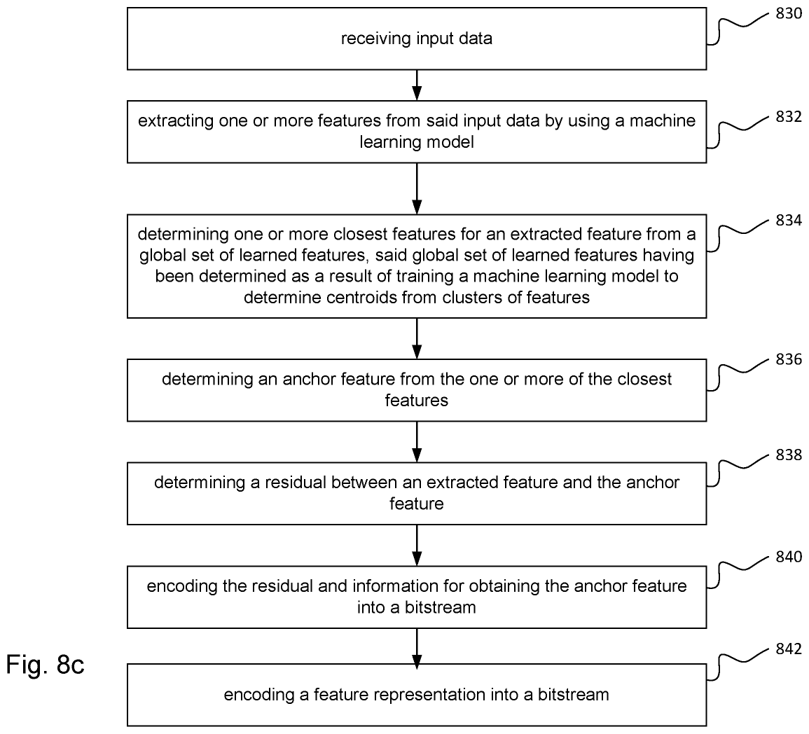

The method for generating a global set of features according to an embodiment is shown in FIG. 8a. The method generally comprises extracting 802 one or more features from an input data by a first machine learning model; performing 804 a task on said one or more features by a second machine learning model; clustering 806 the extracted features by a third machine learning model according to a similarity of the extracted features into one or more clusters; generating 808 the global set of features from a centroid of each cluster; training 810 a feature extractor to extract features to said one or more clusters so that the task is performed with a minimal loss based on a cost value calculation. Each of the steps can be implemented by a respective module of a computer system.

The method for refining a global set of features according to an embodiment is shown in FIG. 8b. The method generally comprises extracting 812 one or more features from an input data by a first machine learning model; determining 814 a closest feature of the one or more extracted features from a global set of features; determining 816 a residual between the one or more extracted features and the closest feature; generating 818 a compressed residual from the residual; determining 820 a compression loss from the compressed residual; generating 822 a reconstructed feature from the compressed residual and the closest feature; determining 824 a construction loss from the reconstructed feature and the one or more extracted features. Each of the steps can be implemented by a respective module of a computer system.

The method for encoding according to an embodiment is shown in FIG. 8c. The method generally comprises receiving 830 input data; extracting 832 one or more features from said input data by using a machine learning model; determining 834 one or more closest features for an extracted feature from a global set of learned features, said global set of learned features having been determined as a result of training a machine learning model to determine centroids from clusters of features; determining 836 an anchor feature from the one or more of the closest features; determining 838 a residual between an extracted feature and the anchor feature; encoding 840 the residual and information for obtaining the anchor feature into a bitstream; encoding 842 a feature representation into a bitstream. Each of the steps can be implemented by a respective module of a computer system.

The embodiments shown in FIGS. 8a-8c can be considered as independent methods. Alternatively, the embodiments can be combined. For example, the a method according to the embodiment can comprise generating a global set of features and refining them. As another example, the method according to an embodiment can comprise encoding bitstream, during which a global set of features is also refined. In the method for refining and method for encoding, said global set of features may have been generated according to an embodiment of FIG. 8a.

An apparatus according to an embodiment comprises means for implementing any of the methods as shown in FIGS. 8a-8c. The means comprises at least one processor, and a memory including a computer program code, wherein the processor may further comprise processor circuitry.

The method for decoding according to an embodiment is shown in 9. The method generally comprises receiving 902 an encoded bitstream; decoding 904 from the bitstream a residual and information for obtaining an anchor feature; decoding 906 a feature representation from the bitstream; obtaining 908 an anchor feature from a global set of learned features by using the information; and reconstructing 910 an input data by adding the anchor feature to the residual. Each of the steps can be implemented by a respective module of a computer system.

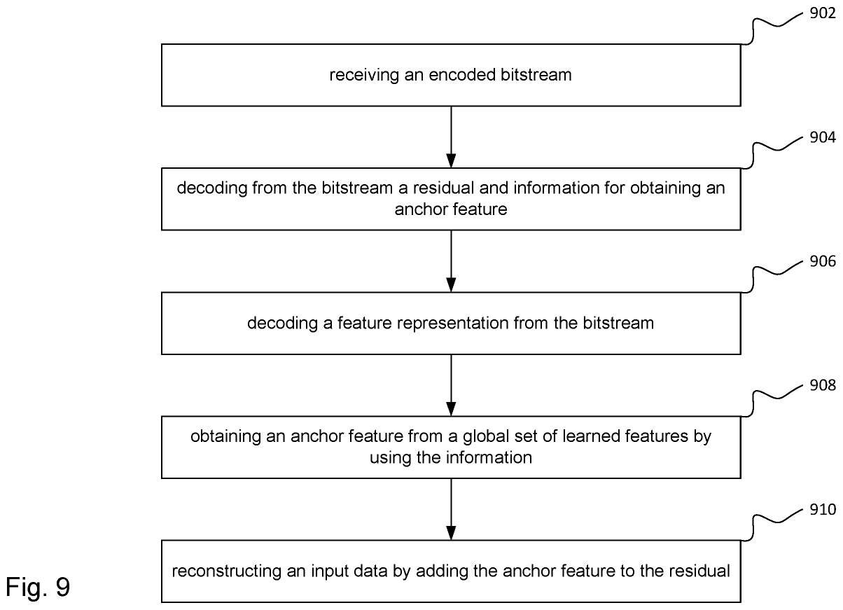

An apparatus according to another embodiment comprises means for implementing the method as shown in FIG. 9. The means comprises at least one processor, and a memory including a computer program code, wherein the processor may further comprise processor circuitry.

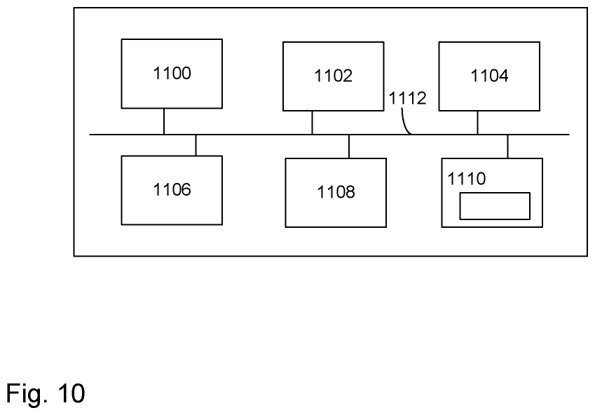

FIG. 10 illustrates an apparatus according to an embodiment. The generalized structure of the apparatus will be explained in accordance with the functional blocks of the system. Several functionalities can be carried out with a single physical device, e.g. all calculation procedures can be performed in a single processor if desired. A data processing system of an apparatus according to an example of FIG. 10 comprises a main processing unit 1100, a memory 1102, a storage device 1104, an input device 1106, an output device 1108, and a graphics subsystem 1110, which are all connected to each other via a data bus 1112. A client may be understood as a client device or a software client running on an apparatus.

The main processing unit 1100 is a processing unit arranged to process data within the data processing system. The main processing unit 1100 may comprise or be implemented as one or more processors or processor circuitry.

The memory 1102, the storage device 1104, the input device 1106, and the output device 1108 may include other components as recognized by those skilled in the art. The memory 1102 and storage device 1104 store data in the data processing system 1100. Computer program code resides in the memory 1102 for implementing, for example, machine learning process. The input device 1106 inputs data into the system while the output device 1108 receives data from the data processing system and forwards the data, for example to a display. While data bus 1112 is shown as a single line it may be any combination of the following: a processor bus, a PCI bus, a graphical bus, an ISA bus. Accordingly, a skilled person readily recognizes that the apparatus may be any data processing device, such as a computer device, a personal computer, a server computer, a mobile phone, a smart phone or an Internet access device, for example Internet tablet computer.

The various embodiments can be implemented with the help of computer program code that resides in a memory and causes the relevant apparatuses to carry out the method. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of various embodiments.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-17. (canceled)

18. An apparatus comprising: at least one processor; and at least one memory including computer program code; wherein the at least one memory and the computer program code are configured to, with the at least one processor, cause the apparatus at least to:
extract one or more features from an input data by a first machine learning model to generate or obtain one or more extracted features;
perform a task on said one or more features by a second machine learning model;
cluster the one or more extracted features by a third machine learning model according to a similarity of the extracted features into one or more clusters;
generate a global set of features from centroids of the one or more clusters; and
train a feature extractor to extract features to said one or more clusters so that the task is performed with a minimal loss based on a cost value calculation.

19. An apparatus according to claim 18, wherein the apparatus is further caused to: reduce a feature dimension, wherein a feature dimension reduction is trained along the clustering.

20. An apparatus according to claim 18, wherein the global set of features comprises blocks or structures of a feature.

21. An apparatus comprising: at least one processor; and at least one memory including computer program code; wherein the at least one memory and the computer program code are configured to, with the at least one processor, cause the apparatus at least to:
receive an input data;
extract one or more features from said input data by using a machine learning model;
determine one or more closest features for an extracted feature from a global set of learned features, wherein said global set of learned features have been determined as a result of training a machine learning model to determine centroids from clusters of features;
determine an anchor feature from the one or more of the one or more closest features;
determine a residual between the extracted feature and the anchor feature;
encode the residual and information for obtaining the anchor feature into a bitstream; and
encode a feature representation into the bitstream.

22. An apparatus according to claim 21, wherein the information for obtaining the anchor feature is an index of a feature in the global set of learned features.

23. An apparatus according to claim 21, wherein the information for obtaining the anchor feature comprises an approximation function.

24. An apparatus according to claim 21, wherein the apparatus is further caused to: select more than one closest features from the global set of learned features randomly.

25. An apparatus according to claim 21, wherein the apparatus is further caused to: select more than one closest features from the global set of learned features by optimizing a rate distortion loss function.

26. An apparatus according to claim 21, wherein the apparatus is further caused to: determine a number of said more than one closest features by an agreement with a decoder.

27. An apparatus comprising: at least one processor; and at least one memory including computer program code; wherein the at least one memory and the computer program code are configured to, with the at least one processor, cause the apparatus at least to:
receive an encoded bitstream;
decode from the encoded bitstream a residual and information for obtaining an anchor feature;
decode a feature representation from the encoded bitstream;
obtain the anchor feature from a global set of learned features by using the information; and
reconstruct an input data by adding the anchor feature to the residual.

28. A method comprising:
extracting one or more features from an input data by a first machine learning model to generate or obtain one or more extracted features;
performing a task on said one or more features by a second machine learning model;
clustering the one or more extracted features by a third machine learning model according to a similarity of the extracted features into one or more clusters;
generating a global set of features from centroids of the one or more clusters; and
training a feature extractor to extract features to said one or more clusters so that the task is performed with a minimal loss based on a cost value calculation.

29. A method according to claim 28, further comprising: reducing a feature dimension, wherein a feature dimension reduction is trained along the clustering.

30. A method according to claim 28, wherein the global set of features comprises blocks or structures of a feature.
